(19) United States
(12) Patent Application Publication
(10) Pub. No.: US 2010/0127138 A1
(43) Pub. Date: May 27, 2010

(54) Extender for a seatbelt receiver

(75) Inventor: Russell Kenneth Whitehead, Lockport, NY (US)

Correspondence Address: Russell K. Whitehead, 3983 Rathke Heights, Lockport, NY, 14094-1194, US

(73) Assignee: Russell Kenneth Whitehead, Lockport, NY (US)

(21) Appl. No.: 12/455,950

(22) Filed: Nov. 2, 2009

Related U.S. Application Data
(60) Provisional application No. 61/137,850, filed on Aug. 4, 2008.

(51) Int. Cl. B60R 22/18; F16M 13/02

(52) U.S. Cl. 248/205.1

(57) ABSTRACT

A height adjusting seat belt anchorage receiver consisting of a metal bar which could be coated or painted to match car color or finish, consisting of holes of differing sizes to anchor to factory seat belt mounting stud bolt with factory hardware at floor level under seat. Factory seat belt buckle attached to bar with various pieces of hardware fasteners through mounting holes. Completing installation and ready for safe use of seat belts in all motor vehicles.

### BRIEF DESCRIPTION OF DRAWING VIEWS

FIG. 1 is a front view of the Extender for a Seatbelt Receiver

FIG. 2 is a side view of the Extender for a Seatbelt Receiver

FIG. 3 is a 5/16×18×1 inch carriage bolt

FIG. 4 is a 5/16 inch flat washer

FIG. 5 is a 5/16 inch lock washer

FIG. 6 is a 5/16×18 lock nut

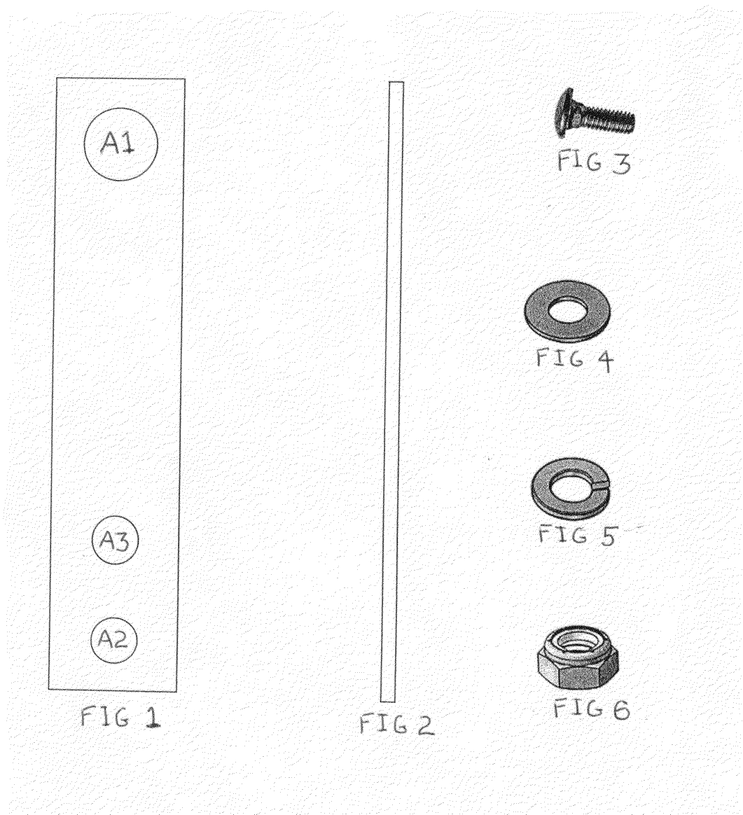

FIG. A1 is a 11/16 inch or 0.6875 hole centered and ⅝ inch from end of bar to center of hole

FIG. A2 is a 29/64 inch or 0.4531 hole centered and ½ inch from end of bar to center of hole

FIG. A3 is a 29/64 inch or 0.4531 hole centered and 1 inch from center to center from holes A2 to A3

### SPECIFICATIONS

Is a flat steel bar stock 6 inches long by 1¼ inches wide and ⅛ inch thick with 1 11/16 Inch or 0.6875 hole located at one end centered on bar located ⅝ inch from end to center of hole. Adjacent end of bar has 2 29/64 inch or 0.4531 holes centered and located ½ inch from end with 2^{nd} hole on 1 inch centers. Fastening hardware consists of 1 15/16×18×1 carriage bolt, 5/16 flat washer, 5/16 lock washer, and 5/16 lock nut. The 11/16 hole is fastened to the factory floor mount with existing factory hardware.

Factory mounted seat belt buckle bracket must be removed from floor mount stud bolt under seat. EXTENDER FOR A SEATBELT RECEIVER with 11/16 inch hole on said stub bolt with washer and nut replaced and tightened. Factory seat belt bracket with buckle is now bolted to extender thru one of the 29/64 inch holes with a 5/16×18×1 carriage bolt, 5/16 inch lock washer and 5/16×18 lock nut. With installation complete, seat belt buckle receiver is raised 6 inches higher than factory position, which makes seat belt easier to attach and release.

1. I have had severe arthritis for many years. With the construction of newer model cars with center consoles and bucket seats, it is very difficult to reach a seatbelt buckle, pull it across your body and find the seatbelt receiver that is typically wedged between the console and seat surface and get it locked in place. This device extends a seatbelt buckle to a height that is easily reachable. The same pain can be experienced by any disabled, handicapped or person of age. For this reason, I invented the EXTENDER FOR A SEATBELT RECEIVER to enable all persons the easy ingress and egress to their seatbelts. This making all users safer and putting them in compliance with the seatbelt safety laws. It is helpful to the drivers as well as passengers, making everyone using the highways and motor vehicles safer in case of an unfortunate accident.
